(19) United States
(12) Patent Application Publication
(10) Pub. No.: US 2009/0282414 A1
(43) Pub. Date: Nov. 12, 2009

(54) Prioritized Resource Access Management

(76) Inventors: Steven J. Branda, Rochester, MN (US); John J. Stecher, Rochester, MN (US); Robert Wisniewski, Rochester, MN (US)

Correspondence Address: IBM-Rochester c/o Toler Law Group, 8500 Bluffstone Cove, Suite A201, Austin, TX, 78759, US

(21) Appl. No.: 12/116,479

(22) Filed: May 7, 2008

(51) Int. Cl. G06F 9/50

(52) U.S. Cl. 718/103

(57) ABSTRACT

Middleware may dynamically restrict or otherwise allocate computer resources in response to changing demand and based on prioritized user access levels. Users associated with a relatively low priority may have their resource access delayed in response to high demand, e.g., processor usage. Users having a higher priority may experience uninterrupted access during the same period and until demand subsides.

### FIELD OF THE INVENTION

The present invention relates generally to computing systems, and more particularly, to managing access to computing resources.

### BACKGROUND OF THE INVENTION

Electronic commerce, or e-commerce, has exploded in step with innovations in network computing technologies and applications. Many businesses solely provide e-commerce services to clients, such as financial services or stock brokerage. Such services are typically provided through a business' website.

With the rapidly growing utilization and popularity of e-commerce services, various systems and methods have been proposed for providing service level management (SLM). SLM refers to procedures used to ensure that adequate levels of services are delivered to service requesters. The basis for SLM is the service level agreement (SLA). An SLA is a contract between a service requestor (customer) and a service provider (e.g., a company) that specifies the minimal acceptable levels for a service. Exemplary of such SLAs include requirements for quality of service (QoS) and security.

QoS refers to the ability to reliably provide access to different applications, users, or data flows, and/or to guarantee a certain level of performance to a data flow. For example, a required bit rate, delay, jitter, packet dropping probability and/or bit error rate may be guaranteed. QoS guarantees become important during instances where network capacity is taxed.

Most companies do not have the necessary computer expertise to create the e-commerce applications they provide to their customers. As a result, many companies purchase programs from other companies who specialize in networking expertise to perform the technical back-end functions of user transactions, while they provide the user interface and front-end functions.

Back-end functions of an online stock trading company may include, but are not limited to controlling trade, storing and managing account information, and handling customer banking. Exemplary front-end functions include creating a distinctive, user-friendly interface unique to the online trading company. The interface allows customers to input data, as well as options and buttons for customers to choose from to indicate to the back-end what functions to perform. Put another way, the front-end application receives customer input and direction, and transmit that information to the back-end application so it may perform the specified tasks requested by that customer.

Ideally, requests and access from the front-end to the back-end and back to the user should occur in a precise and timely fashion, satisfying the above mentioned SLA. Such ideal performance generally occurs in the absence of network congestion and associated competition for resource access. Generally, however, networks do get congested. In such instances, the front-end often cannot effectively convey information to the back-end because all connections are being utilized. A “service unavailable” screen typically appears to the end user, or customer. The back-end may become overwhelmed with requests, shutting down completely, compounding the problem.

Such problems become more convoluted in instances where a company allows customers to purchase different levels of services and associated resource access. In such businesses, customers may elect to pay more for increased levels of service. Continuing with the stock trading example, a company may offer memberships at bronze, silver and gold rates. The SLA entered into by bronze members entails access to a first set of information and other trading resources for a standard price. Silver members may pay for access to a larger set of resources at a more expensive price, and gold members may access the largest amount of resources at the most expensive price.

In the absence of network resource contention, all customers may be able to view displays that access the three back-end systems mentioned above (trading, account information, and banking.) Similarly, in the case of high loads on the back-end of transactions, customers at all three levels of membership typically see their respective accessibility affected. When systems begin to get loaded down, response times will slow across all levels. In other words, gold members can experience essentially the same service delays as bronze members.

Unmet QoS is particularly frustrating for premium users, for whom prioritized access may be desired. That is, the stock trading company may wish to contract gold members such that they can always access all three systems, regardless of system load. The company may wish to guarantee access to the trading and banking functions to silver members, and wish to contract bronze members for trading services at the most. Offering such prioritized service also represents a valuable source of potential revenue to the e-commerce business.

However, dedicating additional databases, processors and other hardware to premium users can be expensive and otherwise inefficient. Moreover, attempting to realize such prioritized access using in-house, front-end code would present a daunting challenge to programmers. Most e-commerce companies would be unwilling to invest and maintain the sort of convoluted front-end code that would be required to tie into an evolving resource network. As such, prioritized QoS memberships remain unrealized for e-commerce applications.

Therefore, what is needed is an improved way to manage resource access and associated QoS with respect to users associated with different levels of access expectations.

### SUMMARY OF THE INVENTION

The present invention provides an improved computer implemented method, apparatus and program product for providing an improved manner of managing resource access within a networked computer system by, in part, determining a performance attribute associated with an accessibility of a resource requested by work requests, each associated with one of a plurality of priorities, and selectively impeding at an application server access to the resource requested by the work requests based upon the performance attribute and a respective priority. Embodiments consistent with the invention may selectively and/or concurrently facilitate access at the application server to the resource requested by the plurality of work requests based upon the performance attribute and a respective priority of the plurality of priorities.

According to an aspect of the invention, embodiments may impede access to work requests of the plurality of work requests associated with a lower priority than the respective priority, while facilitating access to work requests of the plurality of work requests associated with the respective priority. Another or the same embodiment may facilitate access to work requests of the plurality of work requests associated with a higher priority than the respective priority.

Aspects of the invention may bytecode weave annotations within the application server for efficiency considerations. Embodiments consistent with the invention may receive the plurality of work requests requiring access to the resource, and may assign one of a plurality of priorities to each request.

According to another aspect of the invention, embodiments may automatically evaluate the performance attribute and the respective priority to determine that access should be impeded. Towards determining the performance attribute, embodiments may measure a time relating to accessing the resource in response to a work request of the plurality of work requests. The performance attribute may comprise a mathematical average relating to resource access time. According to another aspect of the invention, the performance attribute may be compared to a reference value.

These and other advantages and features that characterize the invention are set forth in the claims annexed hereto and forming a further part hereof. However, for a better understanding of the invention, and of the advantages and objectives attained through its use, reference should be made to the Drawings and to the accompanying descriptive matter in which there are described exemplary embodiments of the invention.

### BRIEF DESCRIPTION OF THE DRAWINGS

FIG. 1 shows a computer system configured to manage resource access in a manner that is consistent with embodiments of the invention.

FIG. 2 shows a block diagram representative of the system components on an application server or other computing system as could be implemented in the system of FIG. 1.

FIG. 3 shows a flowchart having steps executable by the system of FIG. 2 for executing program code that may prioritize user access to resources in accordance with the underlying principles of the present invention.

FIG. 4 shows a flowchart having steps executable by the application server of FIG. 2 for compiling program code configured to prioritize user transactions in accordance with the underlying principles of the present invention.

### DETAILED DESCRIPTION

Embodiments consistent with the underlying principles of the present invention may dynamically allocate access to resources in response to changing demand and based on prioritized user access levels. Middleware may dynamically restrict or otherwise allocate computer resources in response to processor usage, for instance, and in consideration of access permissions assigned to users. Users associated with a relatively low priority may have their resource access delayed in response to high demand, e.g., processor usage. Users having a higher priority may experience uninterrupted access during the same period and until demand subsides.

Embodiments may be realized in a non-application specific manner, but may advantageously be realized in middleware, e.g., an application server. As such, developers may need to only write one set of program code, and the middleware may seamlessly implement the restricted and otherwise prioritized access. Continuing with the e-commerce trading example, bronze, silver and gold members may now benefit from QoS features to ensure appropriate, guaranteed access to their respective resources.

Aspects of the invention may enable developers, administrators or other users to write code to annotate their transactions specifically when performing operations on the back-end systems. Another or the same embodiment may allow for properties to be set on the data sources that connect to the back-end systems, which perform the flow control based on specified user criteria and back-end utilization or warning levels. In this manner, users may be provided powerful tools to meet customer level SLA.

In one example, a developer may write the code. The developer may then define priorities and/or prioritize transactions that include a higher level of importance, and may then add annotations onto a transaction. Program code may weave the annotations. As such, aspects of the invention may utilize runtime bytecode modification to weave in the aspects transparently at runtime. Bytecodes generally include various forms of instruction sets designed for efficient execution by a software interpreter, as well as being suitable for further compilation into machine code. Embodiments may be vendor and platform independent.

Embodiments consistent with the invention may execute the applications in an application server and allow users to demarcate transactional groups within the applications server middleware, as opposed to in user code. Conventionally, more machines have been dedicated to users with more important needs. Embodiments of the present invention allow for a prioritization of transactions within a single instance of an application server/machine.

In addition to CPU usage/threads and memory resources, other exemplary resources may include service providers. Service providers may include any function outside of the direct control of the middleware/application server that provides input to a transaction. Such exemplary resources, e.g., account information, may be restricted to balance prioritized transactions and other work.

Embodiments consistent with the invention allow capping of resource access on the system. Some lower priority users may have to wait, i.e., their activities may be stalled, while allowing others with higher priority access to the resources. In one example, all bronze level users may be required to wait five seconds before they are allowed onto the system at 70% CPU usage on a back-end database. All other higher priority users may access the system as before normal. Such action may ideally keep the CPU usage at 70%, or lower it. If the CPU usage rises to 80%, then all silver level users may be delayed by two seconds. Again, this will hopefully maintain or lower the CPU usage rate on the back-end database until system demand receives. Gold users may continue to access the resources without delay.

In another example, a main page may display information from all three systems above (trading, banking, and account information). In the absence of high resource demand, all customers may be allowed to access all three back-end systems on their main page. Gold customers always should to be able to see all three systems based on the fact that they pay for all services, silver users should always be able to see the trading and banking functions, and bronze level should only be able to see trading information. As load grows on the account information system and banking system, the application server may respond by limiting access on those transactions to the required back-end systems. For instance, the code executed by the server may raise an OverUtilizedError back to the development code. This process may allow time for the load to be limited on the back-end system. This provision may, in turn, allow the system to continue to meet SLA's for higher priority customers. When the two-way communication detects that the back-end system is able to handle more requests and that the warning stage has passed, the system may begin to allow lower priority requests to flow back into the system.

Aspects of the invention may provide an annotation processor. The annotation processor may interpret the annotation that a developer places on transactions or other work. The annotation processor may include an extension and may read in an annotation prior to byte-weaving in runtime code. These processes may handle the interaction with the application server's back-end availability repository. This back-end availability repository may correspond with where the runtime stores information about the back-end systems. Such information may be gleaned from a two-way communication function and/or may be derived from its own statistics.

Another aspect of the invention may include an administration mechanism that allows administrators, developers or other users to apply constraints on specific data sources that access back-end systems. The runtime processes may use the administration mechanism to transparently byte weave in runtime code. The code may manage the interaction with the application server's back-end availability repository. Such management may account for all possible interactions the application code encounters when requesting access to the back-end system.

The two-way communication mechanism may include a component that resides on the application server. The mechanism may maintain an active list of back-end systems status comprising part of the back-end availability repository. The two-way communication mechanism may also include a component on the back-end system(s) that provides data on the system's availability back to the application server.

Another aspect of the invention may include a mechanism used to calculate back-end transactions response times on the application server. The performance monitoring function may then feed into the list of back-end systems for those systems that do not support the two-way communication. This monitoring mechanism may allow monitoring of transaction response times from a back-end system. The mechanism may further cut in when specific administrator defined limits are met. For instance, the mechanism may mark the back-end as unavailable in the back-end availability repository. In some embodiments, the mechanism may allow testing of the back-end system once it has passed the cut off mark to determine if it may be used again.

The back-end availability repository may store all user defined information pertaining to the back-end systems. The repository may provide a highly concurrent access mechanism to avoid bottlenecks during normal production execution. When a back-end goes down or otherwise becomes unavailable, the repository may mark or otherwise designate the back-end system as being unavailable. An exception may subsequently be raised when a call arrives to inquire if the back-end system is available. Conversely, when a back-end system resource is marked as available, again, access to the resource may occur as normal.

Many or all of the above features may be realized in the application server. In providing these features at the disposal of the application server, embodiments may assist in the creation of applications that compensate for back-end conditions and meet SLAs for customers.

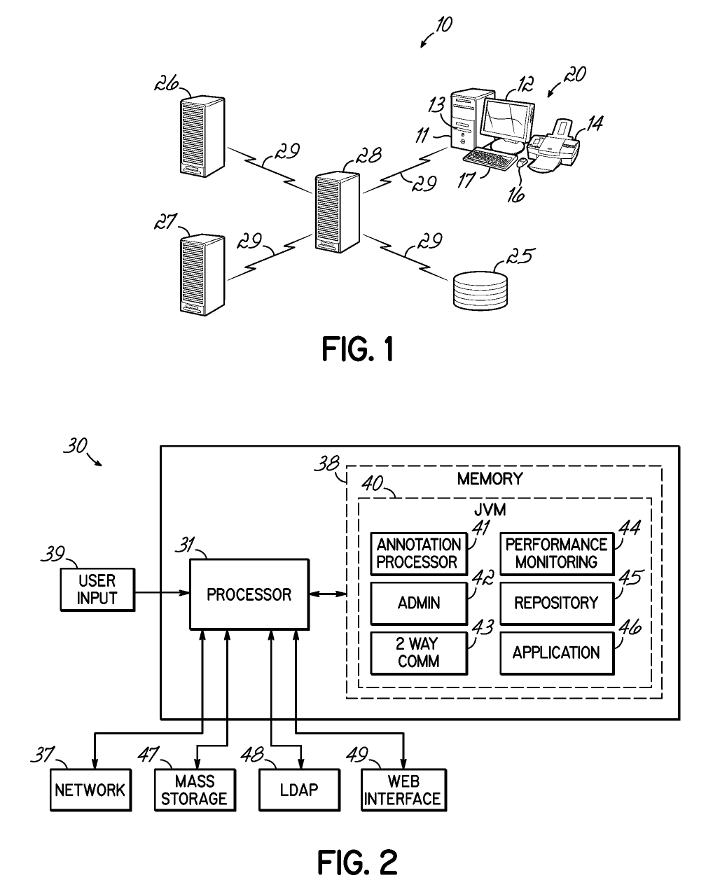

Turning to the Drawings, wherein like numbers denote like parts throughout the several views, FIG. 1 illustrates a computer system 10 configured to manage resource access in a manner that is consistent with embodiments of the invention. The computer system 10 is illustrated as a networked computer system including one or more systems, e.g., client or server computers, 20, 24, 26, 27 and 30 coupled to an application server 28 through a network 29.

Exemplary server 26 may include a Lightweight Directory Access Protocol (LDAP) function where authentication processes may take place. Server 27 may include a web server interface. Each server 26, 27 may include its own connection pool associated with other respective computer components and associated connection mechanisms. Exemplary database 25 of FIG. 1 may persist data. An example of such data may be include data stored in an Oracle format.

The application server 28 may comprise a computer or computer program that provides services to other programs (and their users) in the same or another computer. In one embodiment, application server 28 may include a software engine that delivers applications to client computers or devices, typically through the network 29 and using, for instance, HyperText Transfer Protocol. An exemplary application server 28 may extensively use server-side dynamic content and perform frequent integration with database engines.

The application server 28 may handle most, if not all, of the business logic and data access of the application (a.k.a. centralization). A benefit of an application server 28 may include the ease of application development, since applications need not be programmed. Instead, programs may be assembled from building blocks provided by the application server 28. For example, the application server 28 may allow users to build dynamic content assembled from resources.

Application servers typically bundle middleware to enable applications to intercommunicate with dependent applications, like web servers, database management systems and chart programs. Middleware comprises computer software that connects software components or applications. The software consists of a set of enabling services that allow multiple processes running on one or more machines to interact across a network. Some application servers also provide an (API), making them operating system independent. Portals are a common application server mechanism by which a single point of entry is provided to multiple applications.

Programming may be minimized because the application server 28 may have built-in user interface instructions. The instructions may be contained in output objects, and database data types may be pre-assigned to output objects. When the server is running, data may be requested by the client, causing the assigned user interface instructions to be sent to the client along with the data. Client-side data integrity may be refined by programming hook functions, which may be simultaneously sent to the client.

Application servers may run on many platforms, and the term may apply to different software applications. For instance, an application server consistent with the invention may pertain to servers of web-based applications, such as integrated platforms for e-commerce, content management systems and web-site builders.

The network 29 may represent practically any type of networked interconnection, including, but not limited to, local area, wide area, wireless, and public networks, including the Internet. Moreover, any number of computers and other devices may be networked through the network 29, e.g., multiple additional servers. Furthermore, it should be appreciated that aspects of the invention may be realized by stand-alone, handheld, and associated devices.

Client computer system 20, which may be similar to servers 26, 27, 28, may include one or more processors. The system 20 may also include a number of peripheral components, such as a computer display 12 (e.g., a CRT, an LCD display or other display device), and mass storage devices 13, such as hard, floppy, and/or CD-ROM disk drives. As shown in FIG. 2, the computer system 20 also includes a printer 14 and various user input devices, such as a mouse 16 and keyboard 17, among others. Computer system 20 operates under the control of an operating system, and executes various computer software applications, programs, objects, modules, etc.

Various applications, programs, objects, modules, etc. may execute on one or more processors in server 28 or other computer servers 26, 27, such as a distributed computing environment.

It should be appreciated that the various software components may also be resident on, and may execute on other computers coupled to the computer system 10. Specifically, one particularly useful implementation of an execution module consistent with the invention is executed in a server such as the WebSphere Application Server available from International Business Machines Corporation (IBM). It should be appreciated that other software environments may be utilized in the alternative.

In general, the routines executed to implement the illustrated embodiments of the invention, whether implemented as part of an operating system or a specific application, program, object, module or sequence of instructions, may be referred to herein as computer programs, algorithms, or program code. The computer programs typically comprise instructions that, when read and executed by one or more processors in the devices or systems in computer system 30, cause those devices or systems to perform the steps necessary to execute steps or elements embodying the various aspects of the invention.

Moreover, while the invention has and hereinafter will be described in the context of fully functioning computer systems, those skilled in the art will appreciate that the various embodiments of the invention are capable of being distributed as a program product in a variety of forms. The invention applies equally regardless of the particular type of computer readable signal bearing media used to actually carry out the distribution. Examples of signal bearing media comprise, but are not limited to recordable type media and transmission type media. Examples of recordable type media include volatile and non-volatile memory devices, floppy and other removable disks, hard disk drives, magnetic tape, and optical disks (CD-ROMs, DVDs, etc.). Examples of transmission type media include digital and analog communication links.

FIG. 2 illustrates a suitable software environment for an application server 30 or other computer consistent with the invention. A processor 31 is shown coupled to a memory 38, as well as to several inputs and outputs. For example, user input 39 may be received by processor 31, e.g., through a communication port, among other input devices. Additional information may be passed between the application server 30 and other computer systems in a networked computer system 30 via the network 37. Additional information may be stored to and/or received from mass storage 47. The processor 31 also may optionally output data to a computer display (not shown). The processor 31 may additionally interface with a LDAP 48 and web interface 49, among many other components. It should be appreciated that the application server 30 includes suitable interfaces between the processor 31 and each of the server's components, as is well known in the art.

A Java Virtual Machine (JVM) 40 may reside in the memory 38, and is configured to execute program code on processor 31. In general, a virtual machine is an abstract computing machine. Instructions to a physical machine ordinarily conform to the native language of the hardware, itself. In other cases, the instructions control a software-based computer program referred to as the virtual machine, which in turn, controls the physical machine. Instructions to a virtual machine ordinarily conform to the virtual machine language. For instance, bytecodes represent a form of the program recognized by the JVM 40, i.e., virtual machine language.

As known by one of skill in the art, the JVM 40 is only one of many virtual machines. Most any interpreted language used in accordance with the underlying principles of the present invention may be said to employ a virtual machine. The MATLAB program, for example, behaves like an interpretive program by conveying the user's instructions to software written in a high-level language, rather than to the hardware.

As shown in FIG. 2, the JVM 40 may execute one or more functions, including an annotation processor function 41, an administrative function 42 and a two-way communication function 43. Additional functions may relate to a performance monitoring function 44, a QoS repository function 45 and one or more applications 46. While shown in FIG. 2 as residing within the JVM 40, each function 41, 42, 43, 44, 45 and 46 may comprise a portion of a separate computer in another embodiment.

The annotation processor 41 typically interprets the annotation that a developer places on transactions or other work. The annotation processor 41 may read in an annotation and then byte weave in runtime code. These processes may handle the interaction with the application server's back-end availability repository 45. The back-end availability repository 45 may correspond with where the runtime stores information about the back-end systems. Such information may be gleaned from the two-way communication function 43 and/or may be derived from its own statistics.

Annotation code may define the QoS levels. During runtime, the program code of the annotation processor 41 may pick up the annotations and point weave, or inject, applicable code into the business logic to provide the desired QoS. Business logic may generally include functional algorithms that handle information exchange between a database and a user interface. When the application is deployed in the middleware, the annotation processor 41 may go through the application and determine where the annotations are to facilitate bytecode weaving within the applicable code.

Annotations are typically added by a compiler or programmer in the form of metadata, which is then made available in later stages of building or executing a program. For example, a compiler may use metadata to make decisions about what warnings to issue, or a linker may use metadata to connect multiple object files into a single executable. Various different computer languages support such annotations. Annotation processes facilitated by the annotation processor function 41 may assist in the creation and access of information that is not part of the source file, itself.

The administration function 42 may allow users to apply constraints on specific data sources that access back-end systems. The runtime processes may use the administration mechanism to transparently byte weave in runtime code. The code may manage the interaction with the application server's back-end availability repository 45. Such management may account for all possible interactions the application code encounters when requesting access to the back-end system.

The two-way communication function 43 typically includes a component that resides on the application server 30. The mechanism may maintain an active list of back-end systems status comprising part of the back-end availability repository 45. The two-way communication function 43 may also include a component on the back-end system(s) that provides data on the system's availability back to the application server 30.

The performance monitoring function 44 may be used to calculate back-end transactions response times on the application server. The performance monitoring function 44 may then feed into a list of back-end systems for those systems that do not support the two-way communication function 43. This performance monitoring function 44 may allow monitoring of transaction response times from a back-end system. The mechanism may further initiate when specific administrator defined limits are met. For instance, the performance monitoring function 44 may mark the back-end as unavailable in the back-end availability repository 45. In some embodiments, the performance monitoring function 44 may allow testing of the back-end system once it has passed the cut off mark to determine if it may be used again.

The back-end availability repository 45 may store all user defined information pertaining to the back-end systems. The repository 45 may provide a highly concurrent access mechanism to avoid bottlenecks during normal production execution. When a back-end goes down or otherwise becomes unavailable, the repository 45 may mark or otherwise designate the back-end system as being unavailable. An exception may subsequently be raised when a call arrives to inquire if the back-end system is available. Conversely, when a back-end system resource is marked as available, again, access to the resource may occur as normal.

The JVM 40 may be resident as a component of the operating system of application server 30, or in the alternative, may be implemented as a separate application that executes on top of an operating system. Furthermore, any of the JVM 40, annotation processor function 41, administrative function 42, two-way communication function 43, performance monitoring function 44, QoS repository function 45 and application 46 may, at different times, be resident in whole or in part in any of the memory 38, mass storage 33, network 29, or within registers and/or caches in processor 31.

While aspects of the present invention may lend themselves particularly well to use in connection with a JVM 40, it should be understood that features of the present invention may have application in other object oriented computing systems. Those skilled in the art will recognize that the exemplary environments illustrated in FIGS. 1 and 2 are not intended to limit the present invention. Indeed, those skilled in the art will recognize that other alternative hardware environments may be used without departing from the scope of the invention.

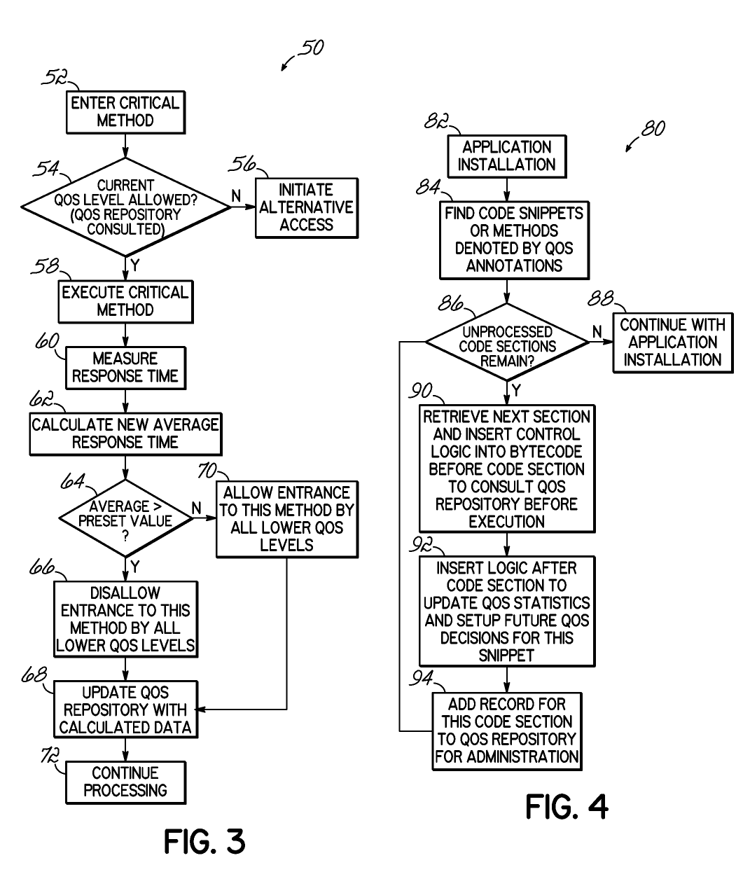

FIG. 3 shows a flowchart 50 having steps executable by the system 30 of FIG. 2 for executing program code that may prioritize user access to resources in accordance with the underlying principles of the present invention. In one sense, the processes of the flowchart 50 show a runtime implementation executable by middleware.

Turning more particularly to the steps of the flowchart 50, the server computer 28 of one embodiment may enter at block 52 a critical method. Processes at block 52 may regard the introduction of code that was inserted during installation by the annotation processor 41, as discussed herein.

The application server 28 may determine at block 54 if the current QoS level is allowed. For this purpose, the application server 28 may consult the (QoS) repository function 45, which may have been setup during annotation processing. The repository function 45 may include a table or other relational memory storing QoS information for each critical section, such as current, average and allowed response times.

Where the current QoS is not allowed at block 54, the application server 28 may initiate a process at block 56 that interrupts or otherwise impedes access to the requested resource. For instance, the server 28 may initiate a throw over error and execute associated logic sequences. The customer may receive a message stating, “Access to the requested information is currently delayed due to high use, please check back in 10 minutes” and/or “Please consider upgrading to gold membership to avoid future delays.”

Where the current QoS level is alternatively allowed at block 54, then the application server 28 may execute at block 58 the critical method. In one scenario, a silver level user may request access (silver level users are allowed unimpeded access based on the current load.) As such, business logic may be executed at block 58, and the performance monitoring function 44 may measure at block 60 the applicable response time for the critical method. The measured response time may be saved for future reference.

The application server 28 may calculate at block 62 a new average response time. In one embodiment, the new average may included an exponential moving average. A moving average, or rolling average, is one of a family of well known techniques used to analyze time series data. In exponential moving averages, more weight may be given to the latest data.

The application server 28 may determine at block 64 if the average determined at block 62, which corresponds to the current QoS level, is greater than some reference value. A suitable reference value may include a number, statically or dynamically determined, as well as a slope, a status or a function.

If the current QoS level is greater than the reference value, then the application server may disallow entrance at block 66 to the method by all lower QoS levels. For instance, if the response time for a gold level user has fallen outside of or is nearing an acceptable QoS range or value, service for lower level user may be impeded until gold level performance improves.

The application server 28 may update at block 68 the QoS repository function 45 with the calculated data. Where the newly computed average is less than the value at block 64, then the application server 28 may alternatively allow entrance at block 70 to the method by all lower QoS levels. The processes at block 70 may include reactivating previously impeded services.

As before, the application server 28 may update at block 68 the QoS repository with the new data, and may continue processing at block 72.

FIG. 4 shows a flowchart 80 having steps executable by the application server 28 of FIG. 2 for compiling program code configured to prioritize user transactions in accordance with the underlying principles of the present invention. Turning more particularly to the flowchart 80, application installation may initiate at block 82. Associated and automated processes may collect annotations, identify methods and inject code, as appropriate.

Program code executing on the application server 28 may locate code at block 84 code snippets or methods denoted by QoS annotations. Exemplary processes may include identifying predefined annotations and their associated configuration information. Such information may regard which methods to call as alternative execution paths, where applicable.

The application server 28 may determine at block 86 if unprocessed code sections remain. An example of a code section may include a QoS annotation. If the unprocessed code sections remain, then the application server 28 may continue at block 88 with application installation.

Where all code sections have been processed at block 86, the application server 28 may alternatively retrieve a next section and insert control logic into a byte code before the code section. This may prompt processes to consult the backend (QoS) repository function 45 before execution at block 90.

The application server 28 may insert at block 92 logic after the code section. Inserting the logic after the applicable code section may prompt an update to the QoS statistics and set up future QoS decisions for this snippet. The application server 28 may add a record at block 94 for this code section to the repository function 45 for subsequent administration.

While the present invention has been illustrated by a description of various embodiments and while these embodiments have been described in considerable detail, it is not the intention of the Applicants to restrict, or, in any way limit the scope of the appended claims to such detail. The invention in its broader aspects is therefore not limited to the specific details, representative apparatus and method, and illustrative example shown and described. Accordingly, departures may be made from such details without departing from the spirit or scope of Applicants' general inventive concept.

What is claimed is:

1. A method of managing resource access within a networked computer system, the method comprising:
determining a performance attribute associated with an accessibility of a resource requested by a plurality of work requests each associated with one of a plurality of priorities; and
selectively impeding at an application server access to the resource requested by the plurality of work requests based upon the performance attribute and a respective priority of the plurality of priorities.

2. The method of claim 1, further comprising selectively facilitating access at the application server to the resource requested by the plurality of work requests based upon the performance attribute and a respective priority of the plurality of priorities.

3. The method of claim 1, further comprising concurrently facilitating access at the application server to the resource requested by the plurality of work requests based upon the performance attribute and a respective priority of the plurality of priorities.

4. The method of claim 1, wherein selectively impeding access to the resource further comprises impeding access to work requests of the plurality of work requests associated with a lower priority than the respective priority, while facilitating access to work requests of the plurality of work requests associated with the respective priority.

5. The method of claim 1, wherein selectively impeding access to the resource further comprises facilitating access to work requests of the plurality of work requests associated with a higher priority than the respective priority.

6. The method of claim 1, wherein selectively impeding access to the resource further comprises bytecode weaving annotations within the application server.

7. The method of claim 1, further comprising receiving the plurality of work requests requiring access to the resource.

8. The method of claim 1, further comprising assigning one of a plurality of priorities to a work request of the plurality of work requests.

9. The method of claim 1, wherein selectively impeding access to the resource further comprises automatically evaluating the performance attribute and the respective priority to determine that access should be impeded.

10. The method of claim 1, wherein determining the performance attribute further comprises measuring a time relating to accessing the resource in response to a work request of the plurality of work requests.

11. The method of claim 1, wherein determining the performance attribute further comprises determining a mathematical average relating to resource access time.

12. The method of claim 1, wherein selectively impeding access to the resource further comprises comparing the performance attribute to a reference value.

13. An apparatus, comprising:
a memory;
program code comprising middleware resident in the memory; and
a processor in communication with the memory and configured to execute the program code to determine a performance attribute associated with an accessibility of a resource requested by a plurality of work requests each associated with one of a plurality of priorities, and to selectively impede access to the resource requested by the plurality of work requests based upon the performance attribute and a respective priority of the plurality of priorities.

14. The apparatus of claim 13, wherein the program code resides within an application server.

15. The apparatus of claim 13, wherein the processor is further configured to execute the program code to selectively facilitate access to the resource requested by the plurality of work requests based upon the performance attribute and a respective priority of the plurality of priorities.

16. The apparatus of claim 13, wherein the processor is further configured to execute the program code to facilitate access to work requests of the plurality of work requests associated with a higher priority than the respective priority.

17. The apparatus of claim 13, wherein the processor is further configured to execute the program code to compare the performance attribute to a reference value.

18. The apparatus of claim 13, wherein the processor is further configured to execute the program code to evaluate the performance attribute and the respective priority to determine that access should be impeded.

19. The apparatus of claim 13, wherein the performance attribute comprises a time relating to accessing the resource in response to a work request of the plurality of work requests.

20. A program product, comprising:
program code comprising middleware configured to determine a performance attribute associated with an accessibility of a resource requested by a plurality of work requests each associated with one of a plurality of priorities, and to selectively impede access to the resource requested by the plurality of work requests based upon the performance attribute and a respective priority of the plurality of priorities; and
a computer readable medium bearing the program code.
